(19) United States
(12) Patent Application Publication
(10) Pub. No.: US 2023/0098348 A1
(43) Pub. Date: Mar. 30, 2023

(54) PORTABLE ELECTRONIC DEVICE WITH ATTACHED ACCESSORY

(71) Applicant: FELLOWES, INC., Itasca, IL (US)

(72) Inventors: Jack Dufelmeier, Chicago, IL (US); Nelson Li, DongGuan City (CN); Xiao Guang Wang, Schaumburg, IL (US); James Edward Losser, St. Charles, IL (US); TaiHoon K. Matlin, Round Lake Beach, IL (US)

(21) Appl. No.: 17/951,935

(22) Filed: Sep. 23, 2022

Related U.S. Application Data
(60) Provisional application No. 63/248,208, filed on Sep. 24, 2021.

(51) Int. Cl. H04M 1/04; G06F 1/16

(52) U.S. Cl. CPC H04M 1/04; G06F 1/163

(57) ABSTRACT

The combination of: a portable electronic device; a base on the portable electronic device and having at least one connector part; and an accessory usable with the portable electronic device and having at least one connector part. The at least one connector part on the base and at least one connector part on the accessory are configured to cooperate such that: a) the accessory is movable from a starting position, fully spaced from the base, to against the base and guidingly relative to the base in translation in a first direction along a first path portion towards one fully connected relationship with the base; and b) with the accessory in the one fully connected relationship with the base the accessory is blocked from being separated from the base.

### BACKGROUND OF THE INVENTION

### Field of the Invention

This invention relates to accessories for portable electronic devices, such as mobile hand held devices and mobile electronic devices, in particular such as cellular phones and tablets, and cases for such devices.

### Background Art

Users of portable electronic devices have sought out accessories to aid the user in holding and interacting with the devices. Kickstands, car mounts, finger loops and PopSocket® grips are some examples of devices that aid the user in holding, positioning, and/or interacting with the device. Other users have sought out accessories such as card holders and wallets. Individual accessories in the prior art have generally been attached without the ability to be readily separated. Commonly, adhesives are used for this purpose. Other accessories have been removably attached on cases or devices utilizing a rotational locking mechanism. US 2019/0138052 is an example of such rotational mechanisms.

### SUMMARY OF THE INVENTION

In one form, the invention is directed to the combination of: a portable electronic device; a base on the portable electronic device; and an accessory usable with the portable electronic device. The base and the accessory each has at least one connector part. The at least one connector part on the base and at least one connector part on the accessory are configured to cooperate such that: a) the accessory is movable from a starting position, fully spaced from the base, to against the base and guidingly relative to the base in translation in a first direction along a first path portion towards one fully connected relationship with the base; and b) with the accessory in the one fully connected relationship with the base the accessory is blocked from being separated from the base.

In one form, the at least one connector part on the base has a holding surface. The at least one connector part on the accessory has a holding surface that moves relative to the holding surface on the base and into confronting relationship with the holding surface on the base as an incident of the accessory moving into the one fully connected relationship with the base, to block the accessory from being moved out of the one fully connected relationship.

In one form, the holding surfaces are placed in confronting relationship as an incident of the accessory being moved in the first direction along the first path portion and into the one fully connected relationship with the base, whereupon the holding surface on the accessory is moved up to and past the holding surface on the base.

In one form, there is a deflectable tab on one of the accessory and base on which the holding surface on the one of the accessory and base is located. With the accessory in the one fully connected relationship, the tab can be repositioned to change a relationship between the holding surfaces on the accessory and base, thereby allowing the accessory to be moved out of the one fully connected relationship.

In one form, the at least one connector part on the accessory and the at least one connector part on the base that cooperate to guide the accessory in translation along the first path portion include at least one rail on one of the accessory and base that cooperates with at least one slot on the other of the accessory and base.

In one form, the accessory is at least one of: a) a finger loop; b) a case; c) a wallet; d) a mounting base; e) a kickstand; and f) a car mount.

In one form, the base is attached to a substantially flat surface on the portable electronic device residing in a first plane. The at least one rail and at least one slot are configured so that the accessory is blocked in movement relative to the base orthogonally to the first plane and away from the substantially flat surface on the portable electronic device.

In one form, the base is attached to a substantially flat surface on the portable electronic device. The tab is repositioned by drawing a part of the tab away from the substantially flat surface on the portable electronic device.

In one form, the accessory is moved in translation against and relative to the base in the first direction from the starting position into the one fully connected relationship.

In one form, the at least one connector part on the base and at least one connector part on the accessory are configured to cooperate such that: a) the accessory is movable from a starting position, fully spaced from the base, to against the base and guidingly against and relative to the base in translation in a second direction along a second path towards another connected relationship with the base; and b) with the accessory in the another fully connected relationship with the base the accessory is blocked from being separated from the base.

In one form, the at least one connector part on one of the base and accessory has a discrete projection that is movable guidingly in a channel defining the at least one connector part on the other of the base and accessory as the accessory is moved in translation in the first path.

In one form, the base is attached to a substantially flat surface on the portable electronic device and resides in a first plane. The at least one rail and one slot are configured to define a captive rail arrangement that blocks the accessory from being drawn away from the substantially flat surface on the portable electronic device orthogonally to the first plane.

In one form, the accessory is moved in translation against and relative to the base in the first direction from the starting position into the one fully connected relationship. With the holding surfaces on the base and accessory in confronting relationship, the accessory is blocked from moving in translation against and relative to the base oppositely to the first direction.

In one form, the at least one connector part on one of the base and accessory has a projection. The at least one connector on the other of the base and accessory has a seat for the projection. The seat has oppositely facing holding surfaces that abut the projection to block movement of the accessory in translation relative to the base in the first direction and oppositely to the first direction.

In one form, the at least one connector on the base has first and second spaced base holding surfaces. The at least one connector on the accessory has first and second spaced accessory holding surfaces. The first and second spaced base holding surfaces are respectively in confronting relationship with the first and second spaced accessory holding surfaces to block the accessory from being moved out of the one fully connected relationship.

In one form, the base has at least one magnet that overlies an area of a surface on the portable electronic device.

In one form, the base is adhesively bonded to the portable electronic device.

In one form, the at least one connector part on the base has a U-shaped edge with spaced substantially parallel lengths and an end portion connecting the spaced substantially parallel lengths to define a “U” shape. The at least one connector part on the accessory has a U-shaped slot that receives at least a part of each of the spaced substantially parallel lengths and the end portion of the U-shaped edge with the accessory in the one fully connected relationship with the base.

In one form, the portable electronic device is one of: a) a cellular phone; and b) a tablet.

In one form, the first and second base holding surfaces are spaced along the first path.

In one form, the portable electronic device includes at least one magnet. The base further includes a gripping layer. The gripping layer is positioned between the magnet on the base and the magnet on the portable electronic device.

In one form, the base includes a pattern with discrete elements to engage a complementary pattern on the portable electronic device.

In one form, the base includes a second connector part. The second connector part is positioned at an angle to the first connector part. The second connector part provides a second path portion for a second connected relationship between the base and the accessory.

### BRIEF DESCRIPTION OF THE DRAWINGS

FIG. 1 is a schematic representation of a portable electronic device and an accessory usable in conjunction therewith and connectable to the portable electronic device according to the present invention;

FIG. 2 is a schematic representation of a base and accessory joined through cooperating connector parts, according to the present invention, with the base either integrally formed with or attachable to the portable electronic device;

FIG. 3 is a plan view of one exemplary form of the inventive base as shown in FIG. 2;

FIGS. 4 and 5 are different top perspective views of the base in FIG. 3;

FIG. 6 is a view of the base as in FIG. 5 and with an exemplary form of the inventive accessory as shown in FIG. 2 being guided therealong towards a fully connected relationship;

FIG. 7 is a view as in FIG. 6 wherein the accessory is further advanced towards the fully connected relationship;

FIG. 8 is a view as in FIGS. 6 and 7 with the accessory advanced to the fully connected relationship;

FIG. 9 is a view of the components in the FIG. 6 configuration and from a different perspective;

FIG. 10 is a view of the components in the FIG. 8 relationship and from a different perspective;

FIG. 11 is an enlarged, bottom view of the accessory in FIGS. 6-10;

FIG. 12 is a bottom perspective view of the accessory in FIG. 11;

FIG. 13 is a cross-sectional view of the accessory taken along line 13-13 of FIG. 11;

FIG. 14 is a bottom perspective view of the accessory different from that in FIG. 12;

FIG. 15 is a cross-sectional view of the base and accessory taken along line 15-15 of FIG. 8;

FIG. 16 is a fragmentary perspective view of the base and accessory in the FIG. 8 relationship;

FIG. 17 is a fragmentary view of the base and accessory in the FIG. 8 relationship and from a different perspective than in FIG. 16;

FIG. 18 is a fragmentary view of the base and accessory in the FIG. 8 relationship and from a different perspective than in FIGS. 16 and 17;

FIG. 19 is a bottom view of the base in FIGS. 3-10 and FIGS. 15-18;

FIG. 20 is a bottom perspective view of the base as shown in FIG. 19;

FIG. 21 is a bottom view of a modified form of the inventive accessory as shown schematically in FIG. 2;

FIG. 22 is a plan view of the accessory in FIG. 21;

FIG. 23 is an end elevation view of the accessory in FIGS. 21 and 22;

FIG. 24 is a side elevation view of the accessory shown in FIGS. 21-23;

FIGS. 25 and 26 are different top perspective views of the accessory in FIGS. 21-24;

FIG. 27 is a bottom perspective view of the accessory in FIGS. 21-26;

FIG. 28 is a plan view of the accessory in FIGS. 21-27 in a fully connected relationship with a base as shown schematically in FIG. 2;

FIG. 29 is an enlarged, cross-sectional view of the base and accessory taken along line 29-29 of FIG. 28;

FIG. 30 is a bottom view of the components in the FIG. 28 relationship;

FIG. 31 is a plan view of the components in the FIG. 28 relationship;

FIG. 32 is an end elevation view of the components in the FIG. 28 relationship;

FIG. 33 is a side elevation view of the components in the FIG. 28 relationship;

FIGS. 34 and 35 are different top perspective views of the components in the FIG. 28 relationship;

FIG. 36 is a bottom perspective view of the components in the FIG. 28 relationship;

FIG. 37 is a plan view of a modified form of the inventive accessory as shown schematically in FIG. 2;

FIG. 38 is a bottom view of the accessory in FIG. 37;

FIG. 39 is an end elevation view of the accessory in FIGS. 37 and 38;

FIG. 40 is a side elevation view of the accessory shown in FIGS. 37-39;

FIGS. 41-43 are different top perspective views of the accessory as shown in FIGS. 37-40;

FIG. 44 is a bottom perspective view of the accessory as shown in FIGS. 37-43;

FIG. 45 is an enlarged, schematic representation of an alternative form of one of the connector parts shown on the accessory in FIGS. 37-44;

FIG. 46 is a plan view of a modified form of the inventive base, as shown schematically in FIG. 2, to which the accessory in FIGS. 37-44 is connectable;

FIG. 47 is a bottom view of the base in FIG. 46;

FIG. 48 is an end elevation view of the base in FIGS. 46 and 47;

FIG. 49 is a side elevation view of the base shown in FIGS. 46-48;

FIGS. 50-52 are different top perspective views of the base shown in FIGS. 46-49;

FIG. 53 is a bottom view of a further modified form of the inventive base, as shown schematically in FIG. 2;

FIG. 54 is an end elevation view of the base in FIG. 53;

FIG. 55 is a side elevation view of the base as shown in FIGS. 53 and 54;

FIG. 56 is a plan view of the base shown in FIGS. 53-55;

FIGS. 57-59 are different top perspective views of the base shown in FIGS. 53-56;

FIG. 60 is a top perspective view showing further alternative forms of the inventive base and accessory as shown schematically in FIG. 2;

FIG. 61 is an exploded, perspective view showing cooperating gripping components, one each on a portable electronic device and an exemplary accessory, with the exemplary accessory as shown in FIGS. 21-36;

FIG. 62 is an exploded view as in FIG. 61 from a different perspective;

FIG. 63 is an enlarged, side elevation view of the components in FIGS. 61 and 62 in assembled relationship;

FIG. 64 is a cross-sectional view of the assembled components taken along line 64-64 of FIG. 61;

FIG. 65 is an exploded, perspective view of the accessory as in FIG. 62 in relationship to a portable electronic device in the form of a cellular phone;

FIG. 66 is an exploded view as in FIG. 65 and from a different perspective;

FIG. 67 is a view as in FIG. 65 wherein an adhesive component is provided on the accessory as shown in FIG. 60;

FIG. 68 is an exploded view as in FIG. 67 from a side perspective;

FIG. 69 is an enlarged, bottom view of the accessory in FIG. 67 before being adhered to the portable electronic device;

FIG. 70 is a view as in FIG. 69 wherein the adhesive layer is compressed upon being adhered to the portable electronic device;

FIG. 71 is a view as in FIG. 68, with an enlarged, section view showing connecting elements between the accessory and the portable electronic device, including cooperating magnets;

FIG. 72 is a view of the enlarged portion in FIG. 71 with the accessory adhered to the portable electronic device;

FIG. 73 is a schematic representation of a further modified form of accessory including a finger loop that is potentially reconfigurable; and

FIG. 74 is a schematic representation of one possible form of a mounting portion on the accessory in FIG. 73 and having a recess to store the collapsed finger loop.

### DETAILED DESCRIPTION OF THE PREFERRED EMBODIMENT

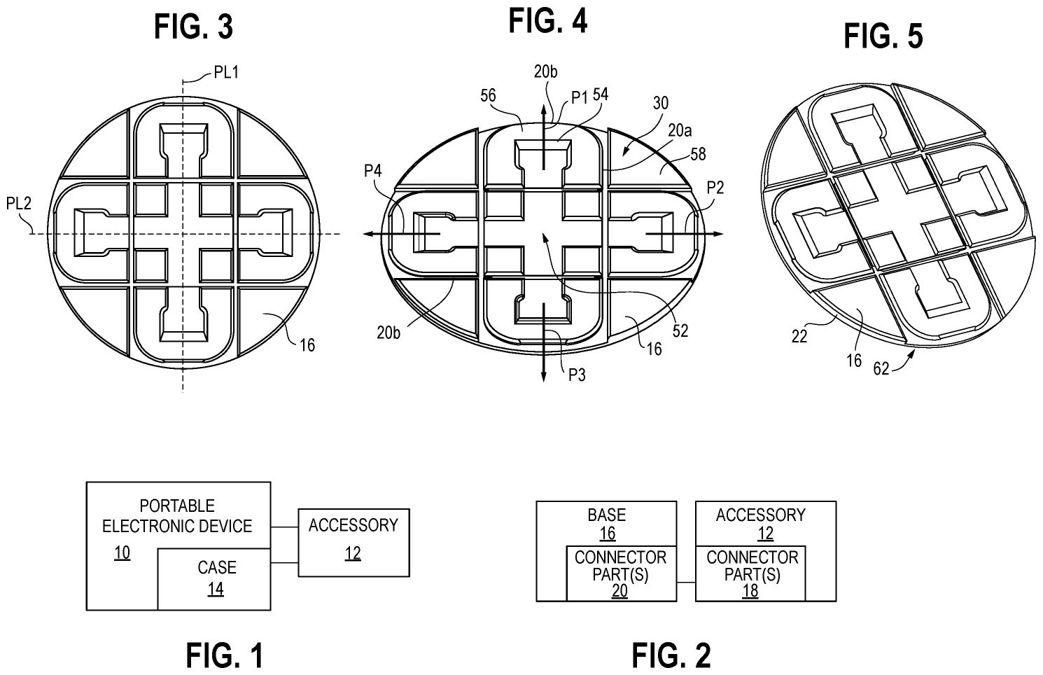

The present invention is directed to portable electronic devices, as shown schematically at 10 in FIG. 1. The portable electronic device 10 is shown schematically to encompass virtually an unlimited number of forms thereof, amongst which are cellular phones, tablets, etc. The phone and tablet are exemplary in nature only.

Accessories, as also shown schematically at 12 in FIG. 1, are commonly used and/or transported with these portable electronic devices 10. As just examples, the accessory 12 may take the form of a kickstand, a car mount, a finger loop, a PopSocket® grip, etc. These accessories facilitate, or complement, use of the portable electronic device 10. Other accessories, such as a wallet, card holder, etc., may be conveniently transported with the portable electronic device 10.

The accessory 12 may be attached directly to the portable electronic device 10, or a case 14 therefor.

As shown in FIG. 2, a base 16 is provided on the portable electronic device 10 and/or case 14 therefor and may be integrally formed therewith. Alternatively, and in the preferred embodiments described hereinbelow, the base 16 is a separate component that is attached to the portable electronic device 10 and/or case 14, either at time of manufacture or in the aftermarket.

The accessories 12 each has at least one connector part 18 configured to cooperate with at least one connector part 20 on the base 16 to facilitate connection of the accessory 12 to the portable electronic device 10, with preferably, but not necessarily, the ability to separate the accessory 12 from the portable electronic device 10, as to replace the accessory with the same or a different accessory or allow the portable electronic device 10 to be used without any connected accessory.

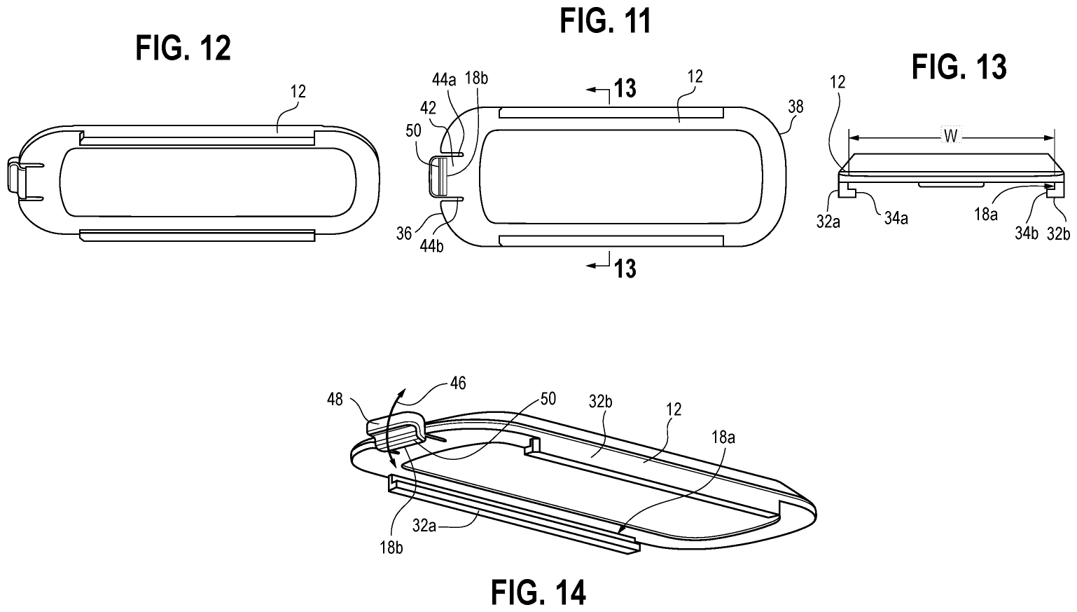

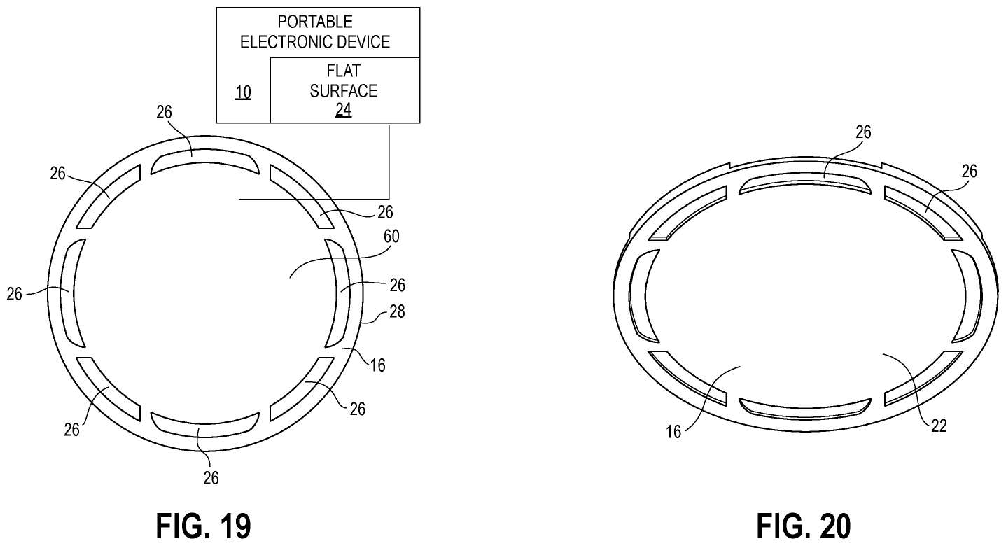

One exemplary form of the base 16 is shown in FIGS. 3-20. The base 16 is designed to maintain the connected accessory 12 in any of four different angular relationships, each turned 90° from the next. The accessory 12 depicted is actually only a mounting portion designed to receive another component to make up the accessory 12. However, for purposes of simplicity, the depicted mounting portion in FIGS. 3-20, and in other embodiments herein, will be considered to be a generic form of the accessory 12.

The base 16 has a substantially flat bottom side 22 to be placed facially against a flat surface 24 on the portable electronic device 10, or a case 14 thereon/therefor.

In this embodiment, discrete magnets 26 are placed in an arcuate pattern near the perimeter 28 of the base 16 to facilitate securement of the bottom side 22 of the base 16 to the portable electronic device 10 using Apple's “MagSafe” technology. Additional securing structure, as described below, may supplement the magnetic holding forces or provide a substitute therefor.

The upper side 30 of the base 16 has the aforementioned connector parts 20 that cooperate with the connector parts 18 on the accessory 12.

The connector parts 20 on the base 16 cooperate with the connector parts 18 on the accessory 12 such that the accessory 12 is movable from a starting position, fully spaced from the base 16, in translation in four different paths P1, P2, P3, P4 towards four fully connected relationships with the base 16, wherein the accessory 12 is blocked from being separated from the base 16.

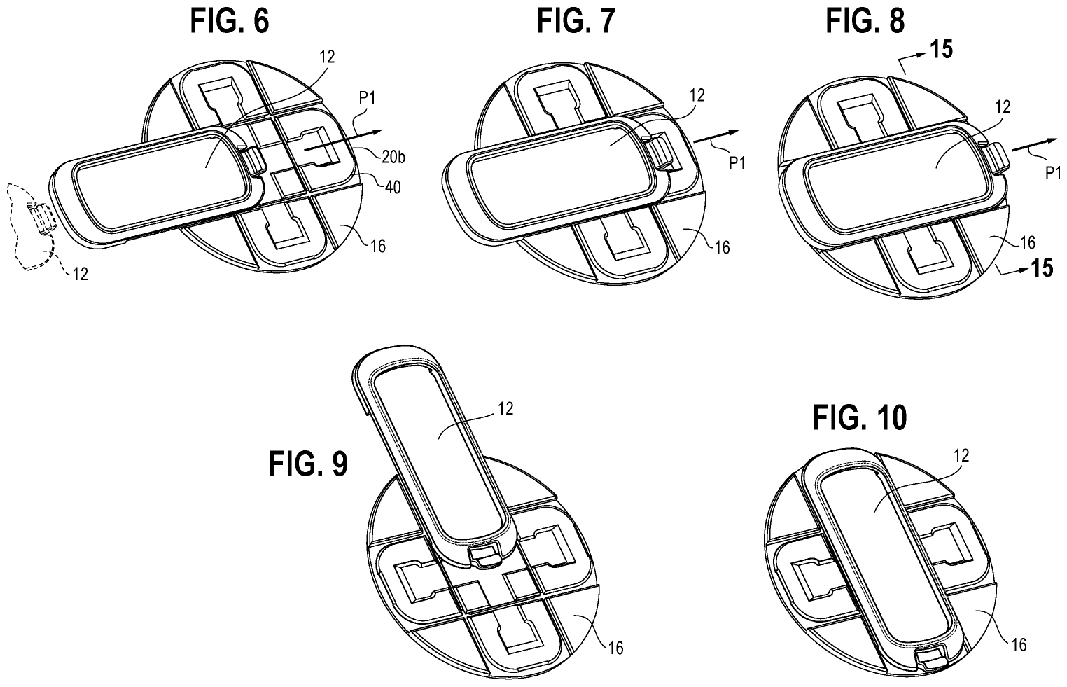

The sequence of FIGS. 6-8 shows the progression of the accessory 12 as it is moved from the starting position, depicted in dotted lines, fully to the one fully connected relationship in FIG. 8.

The accessory 12 has spaced, depending edges 32a, 32b that are substantially parallel to each other and have inturned ends 34a, 34b, respectively. The edges 32a, 32b and ends 34a, 34b cooperatively define an elongate slot/connector part 18a of substantially constant width W over a majority of the length of the accessory 12 between a leading end 36 and trailing end 38 thereof.

The base 16 is undercut to define a peripheral flange/connector part 20a with a width W1 slightly less than the width W of the slot/connector 18a. The flange/connector part 20a functions as a guide rail.

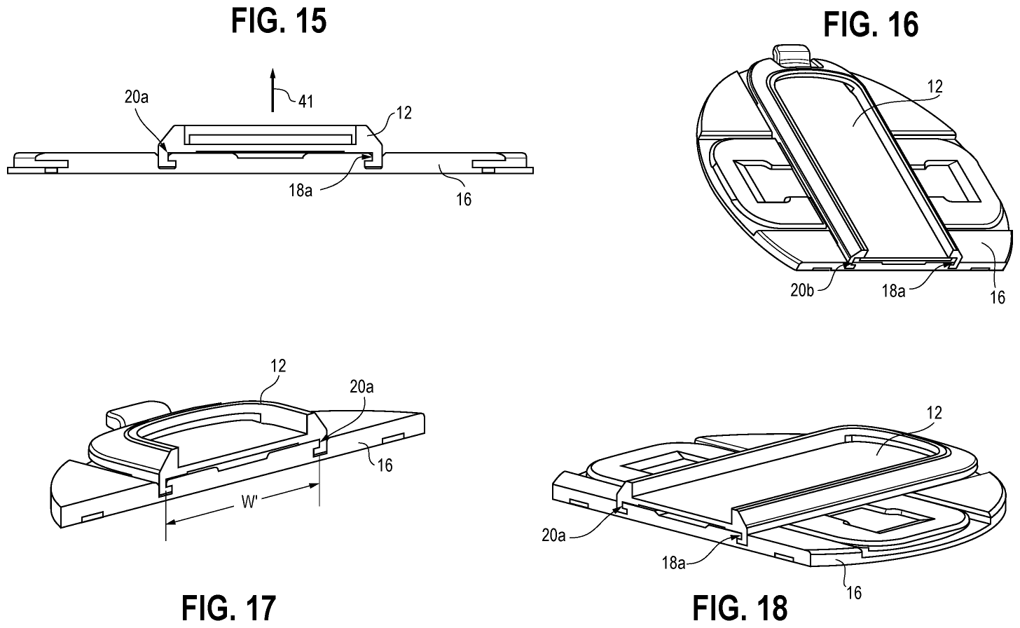

With the accessory 12 in the dotted line starting position of FIG. 6, the width W of the slot/connector part 18a is aligned with the width W1 of the flange/connector part 20a, whereupon the accessory 12 can be guidingly moved against the base in translation in a first direction along the path P1. A captive rail arrangement results, whereby the accessory 12 is blocked from being drawn “upwardly” away from the base 16 in the direction of the arrow 41 in FIG. 15.

Many variations of a cooperating “rail” and “slot” arrangement are contemplated. The rail portions may be on either the base 16 or accessory 12. Multiple rails may be provide on the base 16 and/or accessory 12. For example, the inturned ends 34a, 34b by themselves may be considered to be rails/connector parts 18.

The leading end 36 of the accessory 12 has a tab 42 formed by slits 44a, 44b, which produces a cantilever mount, allowing the tab 42 to be bent through a live hinge in an arcuate path, as indicated by the double-headed arrow 46, relative to the rest of the accessory 12. The tab 42 has a gripping end 48 which can be comfortably engaged to facilitate bending of the tab 42 relative to the remainder of the accessory 12.

The tab 42 additionally has a lower ramp surface 50 adjacent to which there is a holding surface/connector part 18b. The holding surface/connector part 18b is configured to cooperate with a vertically extending holding surface/connector part 20b on the base 16.

As the accessory 12 is advanced from the starting position in FIG. 6 progressively towards the one fully connected relationship with the base, as shown in FIG. 8, the tab 42 functions as one of the connector parts 18 and moves guidingly within an undercut guide channel 52 which functions as a cooperating connector part 20 on the base 16. Eventually, the tab 42 encounters a ramp surface 54 on the base 16 which deflects the tab 42 “upwardly”, in the direction of the arrow 41, to allow the ramp surface 54 to slide along an upper surface portion 56 on the base 16 until the holding surface/connector part 18b moves past the vertically extending holding surface/connector part 20b on the base 16, whereupon the residual forces in the bent tab 42 cause the tab 42 to deflect downwardly and place the holding surfaces/connector parts 18b, 20b in confronting relationship to block the accessory 12 from being moved out of the fully connected relationship as by urging it in a translational direction opposite that moved in the path portion P1.

Accordingly, the accessory 12 can be placed in its first fully connected relationship by a simple translational movement of the accessory 12. Essentially, a snap connection results as the holding surfaces/connector parts 18b, 20b are placed in confronting relationship.

When it is desired to separate the accessory 12, the gripping end 48 of the tab 42 can be manipulated to reposition the tab upwardly and bring the holding surfaces 18b, 20b out of confronting relationship, whereupon the accessory 12 can be translated oppositely to the assembly direction indicated by the arrow P1.

The base 16 is symmetrical around two orthogonal vertical planes PL1, PL2, as seen in FIG. 3. Accordingly, the accessory 12 can be directed selectively into any of four different fully connected relationships in the same manner.

A corresponding flange/connector part 20b is used to guide the accessory 12 in the paths P2, P4. Where the flanges 20a, 20b cross, they are interrupted to permit the accessory 12 to be translated into any of the four different fully connected relationships with the base 16 without any interference.

It should be understood that the precise configuration of each of the base 16 and accessory 12 is not critical. For example, the disk-shaped footprint of the base 16 conveniently accommodates the different angular orientations of the accessory 12 and facilitates an optimal annular arrangement of the magnets 26 to utilize the MagSafe technology. The disk shape also produces a relatively large footprint that permits secure fixation of the base 16 to the portable electronic device 10.

The accessory 12 has a generally rectangular shape with sufficient width to create a stable rail and slot arrangement for the connectors 18, 20.

The base 16 has a relatively thin profile so as not to project significantly away from the flat surface 24 on the portable electronic device 10. Generally, the thickness between generally parallel top and bottom flat surfaces 58, 60, respectively, is less than 2.2 millimeters.

The base 16 might be modified so that the accessory 12 can be advanced relative to the base 16 into only a single fully connected relationship. Alternatively, more than five guided paths may be provided. There is no limitation as to the orientation of the path(s) or their relative orientations.

With this embodiment, the tab 42 is drawn away from the flat surface 24 on the portable electronic device 10 upon which the accessory 12 is mounted to effect release of the accessory 12. This placement of the tab 42 on the accessory allows the base 16 to have a thinner profile than it would have if the tab 42 was retained on the base. Further, if the tab 42 remains on the base 16 with the accessory 12 separated, it creates a protrusion that may snag on objects as the portable electronic device 10 is maneuvered.

It should be understood that the perimeter edge 62 of the base 16 in this and all embodiments herein, may take many different forms. The perimeter edge 62 may, if viewed in cross-section, be both straight and perpendicular to substantially parallel upper/top and lower/bottom base surfaces 58, 60. Alternatively, the edge 62 may be angled, taper, be stepped, etc.

The perimeter edge 62 may have one or more flat edge portions.

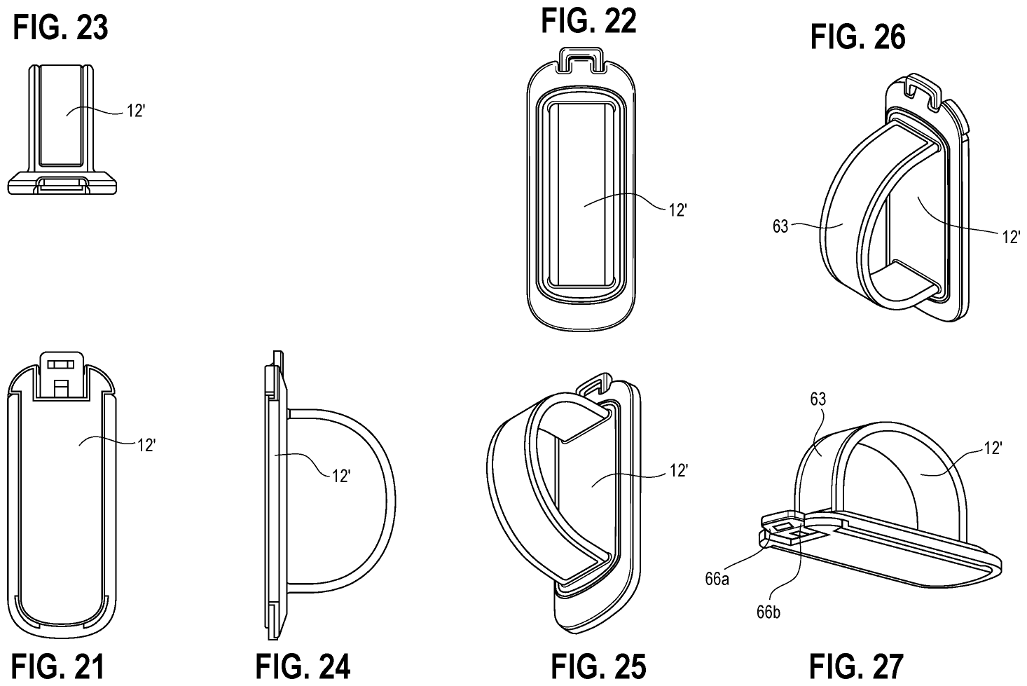

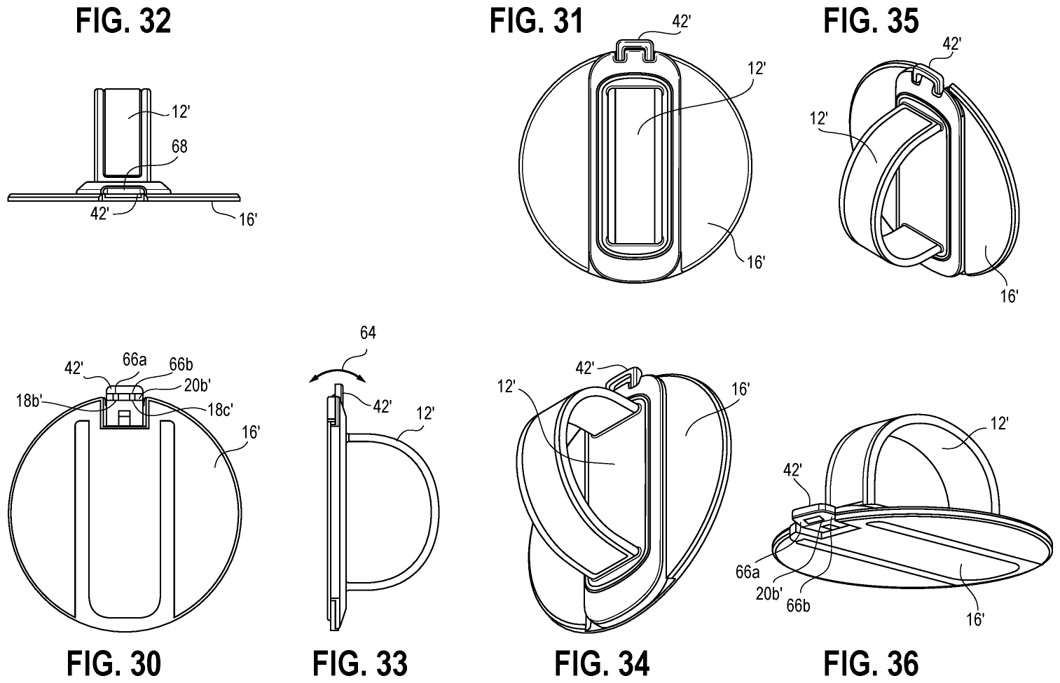

An alternative form of base is shown at 16′, with an exemplary alternative form of accessory 12′, including a finger loop 63, in FIGS. 21-36.

The base 16′ has a disk shape with a thickness between substantially parallel top and bottom surfaces 58′, 60′, respectively.

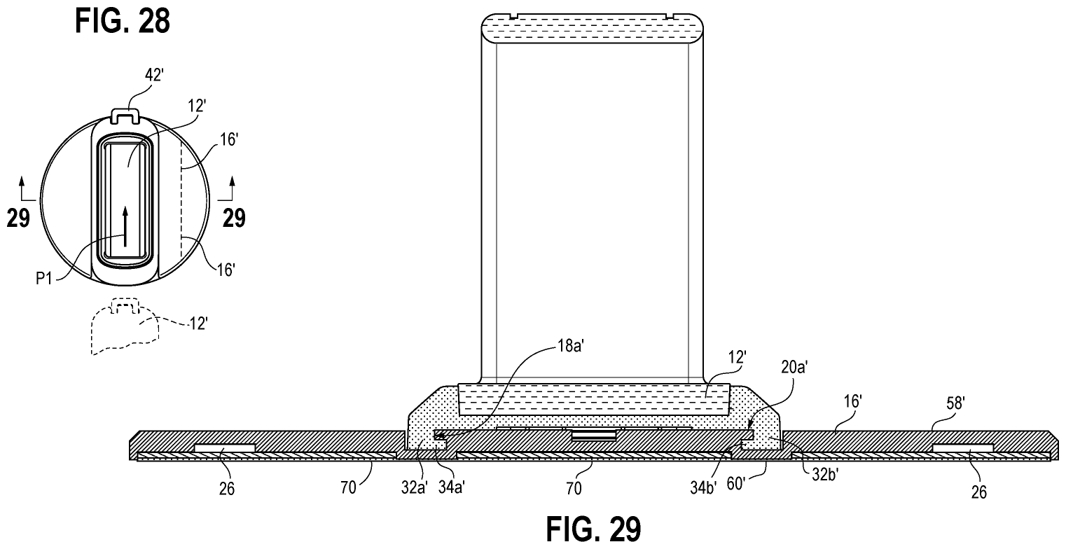

The accessory 12′ has depending, substantially parallel edges 32a′, 32b′ with inturned ends 34a′, 34b′, respectively, cooperatively forming a slot/connector part 18a′ that cooperates with a flange/connector part 20a′ on the base 16′ functioning as a rail to guide the accessory 12′ from a starting position, as shown in dotted lines in FIG. 28, fully spaced from the base 16′, in the first direction along a first path, as indicated by the arrow P1, toward the fully connected relationship as shown in solid lines in FIG. 28. This slot and rail arrangement is similar to that for the previously described accessory 12 and base 16.

The accessory 12′ has a tab 42′ that is bendable generally in an arcuate path, as indicated by the double-headed arrow 64. The tab 42′ has associated spaced projections 66a, 66b that are cammed upwardly as they slide against an upwardly facing surface portion 68 on the base 16′ as the accessory 12′ is advanced towards the fully connected relationship with the base 16′.

Once the accessory 12′ is in fully connected relationship with the base 16′, the restoring forces in the bent tab 42′ cause the tab to relax so that the projections 66a, 66b move downwardly to place holding surfaces/connector parts 18b′, 18c′, respectively thereon, in confronting relationship with a holding surface/connector part 20b′ on the base 16′.

By grasping the tab 42′ and bending the same upwardly, the holding surfaces/connector parts 18b′, 18c′ and 20b′ can be taken out of confronting relationship, thereby allowing the accessory 12′ to be translated guidingly along the base 16′ oppositely to the connecting direction of movement.

The base 16′ is shown with a disk shape to accommodate an annular array of magnetic components 26 shown in undercut relationship to the base 16′ in FIG. 29.

An adhesive layer 70 is placed similarly in an undercut seat overlying the magnetic components 26 to facilitate securement of the base 16′ to the portable electronic device 10.

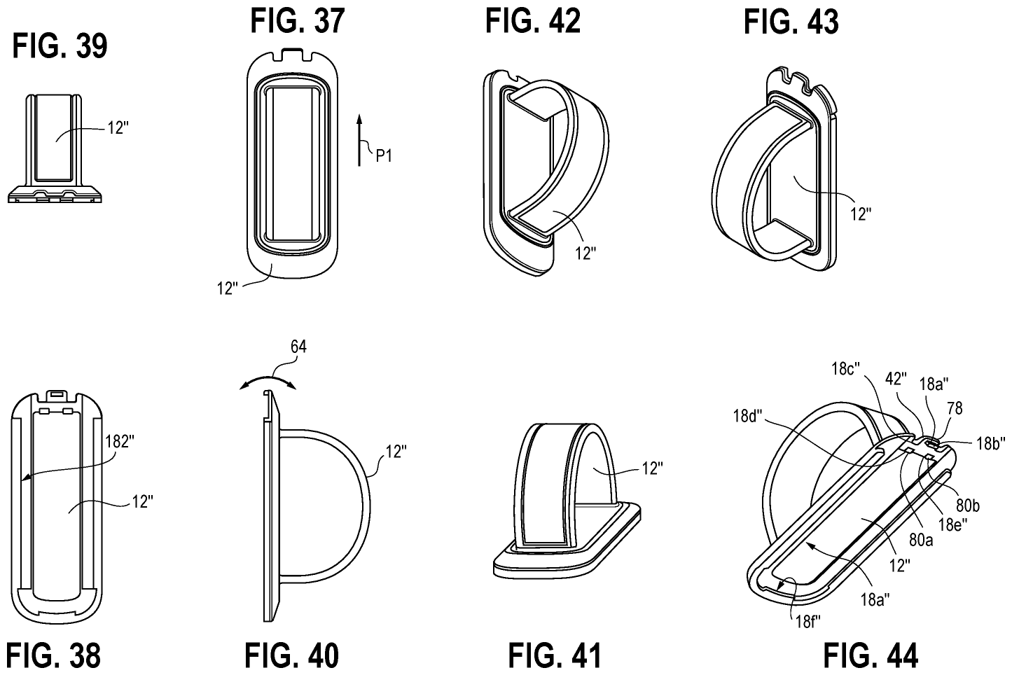

A further modified form of base 16″, with a further alternative exemplary form of accessory 12″, is shown in FIGS. 37-51.

The base 16″ has a generally rectangular shape as viewed in plan. An outturned flange defines a U-shaped edge/connector part 20a″ consisting of substantially parallel lengths 74a, 74b and an end portion 76 connecting the lengths 74a, 74b.

The edge/connector part 20a″ defines a rail, over the extent of the lengths 74a, 74b, that moves guidingly in a slot/connector part 18a″ on the accessory 12″.

The accessory 12″ has three different spaced projections 78, 80a, 80b defining connector parts that cooperate with connector parts on the base 16″.

The leading projection 78 has oppositely facing surfaces/connector parts 18a″, 18b″ which can be directed into a channel/connector part 20b″ to align the accessory 12″ for connection to the base 16″ and additionally guide the accessory 12″ towards its fully connected relationship with the base 16″.

A tab 42″ on the base 16″ is bendable in an arcuate path as indicated by the double-headed arrow 84 in FIG. 40.

As the accessory 12″ is advanced in its assembly path as indicated by the arrow P1 in FIG. 37, the projection 78 engages an upper surface portion 86 on the base 16″, causing the tab 42″ to bend downwardly until the accessory realizes the fully connected relationship with the base 16″, whereupon the tab 42″ is allowed to spring back, placing a holding surface/connector part 18c″ on the projection 78 in confronting relationship with a holding surface/connector part 20c″ on the base 16″.

During this connecting process, the projections 80a, 80b on the accessory 12″ are additionally caused to bear against projections 88a, 88b, respectively, on the base 16″. The deflection of the tab 42″ is adequate to allow the projections 80a, 80b to move past the projections 88a, 88b. Once the tab 42″ springs back towards an undeformed state, holding surfaces/connector parts 18d″, 18e″, respectively on the projections 80a, 80b, are respectively placed in confronting relationship with holding surfaces/connector parts 20d″, 20e″ on the base 16″.

In this embodiment, the tab 42″ is repositioned by being pressed downwardly to move the holding surface/connector part pairs out of confronting relationship.

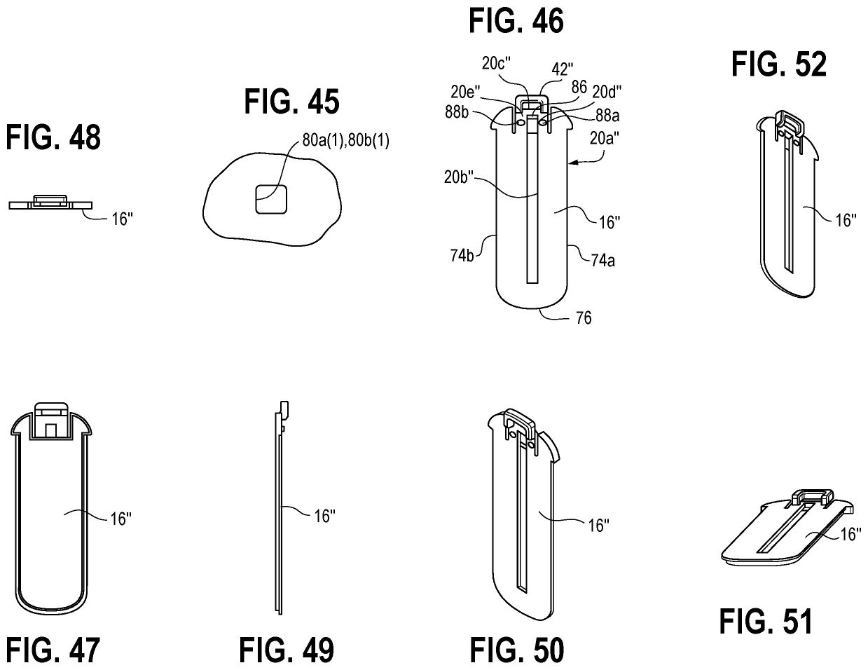

In an alternative form, the projections 80a, 80b may be replaced by depressions/seats as shown at 80a(1), 80b(1) in FIG. 45. The surfaces bounding the depressions 80a(1), 80b(1) act as holding surfaces/connector parts 22 that cooperate with the holding surfaces/connector parts on the projections 88a, 88b.

This creates redundant holding structure for the accessory 12″ in its fully connected relationship with the base 16″. Further, the projections 88a, 88b may be situated so as to engage holding surfaces on the base 16″ as in the event that the tab 42″ is inadvertently bent as might otherwise release the accessory 12″ from the base 16″.

It should be noted that all of the cooperating connector parts on all versions of the accessory 12 and base 16 may be reversed from the forms shown. That is, the cooperating parts shown on the base 16 could be placed on the accessory 12 to cooperate in like manner with cooperating parts moved from the accessory 12 to the base 16.

In this embodiment, the base 16″ is designed for compactness by having a reduced footprint. Accordingly, the base 16″ is not designed specifically to accommodate magnets for the Apple MagSafe feature.

The finger ring design is substantially the same as that on the accessory 12′.

In this embodiment, the end portion 76 of the edge/connector part 20a″ advances into a complementary slot portion/connector part 18f″ on the accessory 12″ to provide a more stable and secure mount for the accessory 12″, particularly at the end opposite the end with the projection 78.

In FIGS. 54-59, a further modified form of base is shown at 16″. The base 16′″ differs from the base 16″ primarily by reason of having a disk shape to accommodate an array of magnet parts 26.

Further, the projections 88a, 88b on the base 16″ are eliminated, whereby the single holding surface/connector part is at 20c′″, corresponding to the holding surface/connector part 20c″ on the base 16″.

On both bases 16″, 16′″, the cooperating accessory may be designed to capture a portion of the base 16″, 16′″ between the holding surface/connector part 20c″ and end portion 76 of the edge/connecting part 20a″ on the base 16 and the corresponding holding surface/connector part 20c′″ and end portion 76″ on the edge/connecting part 20a′″ on the base 16′″.

Further, an upwardly opening U-shaped receptacle/seat is defined at 89 through which a projection 78″ on an accessory 12′″ moves as the accessory 12′″ is advanced towards its fully connected relationship with the base 16″. The projection moves over and past a holding surface/connector part 20a′″ before realizing the fully connected relationship with the base 16′″. In the event that the tab 42″ is inadvertently depressed to release the accessory 12″, a holding surface/connector part 18a′″ will encounter the holding surface/connector part 20d″ bounding the receptacle/seat 89, thereby blocking further translational movement of the accessory 12″ away from the fully connected relationship. This blocking force can be overcome by a preselected moderate force applied by a user in the event that separation of the accessory 12′″ is desired.

The base 16″ also has this safety feature.

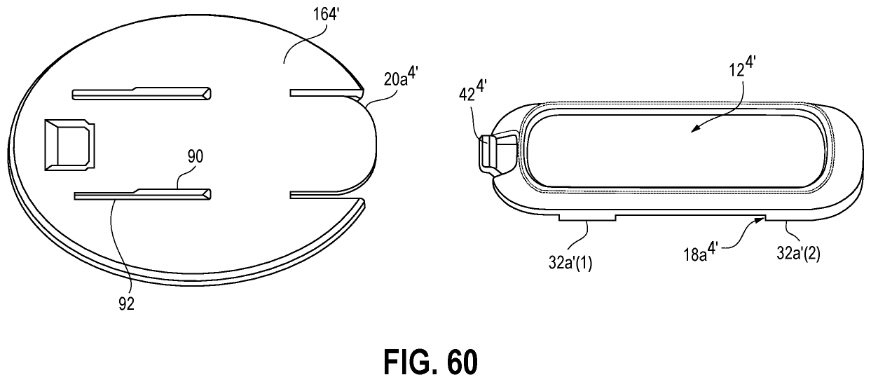

In FIG. 60, further modified forms of accessory and cooperating base are shown respectively at 12^{4′} and 16^{4′}. With the accessory 12^{4′}, the edges 32a′, 32b′ and inturned ends 34a′, 34b′ extend continuously over a majority of the diameter of the disk-shaped base 16^{4′}.

With the accessory 12^{4′}, each of the corresponding edges and inturned ends is interrupted. As shown at one exemplary side, discrete edge parts 32a′(1) and 32a′(2) with inturned ends (not shown) together perform the function of the edge 32a′ and inturned end 34a′.

To engage the accessory 12^{4′}, the edge part 32a′(1) is aligned over an enlarged entry opening 90 which allows the inturned end on the edge part 32a′(1) to be passed therethrough, whereupon the edge part 32a′(1) can be guided through a narrower slot portion 92 with the inturned end on the edge part 32a′(1) blocked by the underside of the base 16^{4′} from being drawn upwardly away from the base 16^{4′}.

The U-shaped flange/connector part 20a^{4′} cooperates with the complementarily-shaped slot/connector part 18a^{4′} on the accessory 12^{4′} as similarly configured parts cooperate between the accessory 12″ and base 16″, as described previously.

The connector parts on the accessory 12^{4′} and base 16^{4′} cooperate the same on each side of the accessory 12^{4′}.

In the depicted form, a tab 42^{4′} is provided on the accessory 12^{4′} and is repositioned upwardly as the tab 42 to allow release of the accessory 12^{4′} from the fully connected relationship with the base 16^{4′}.

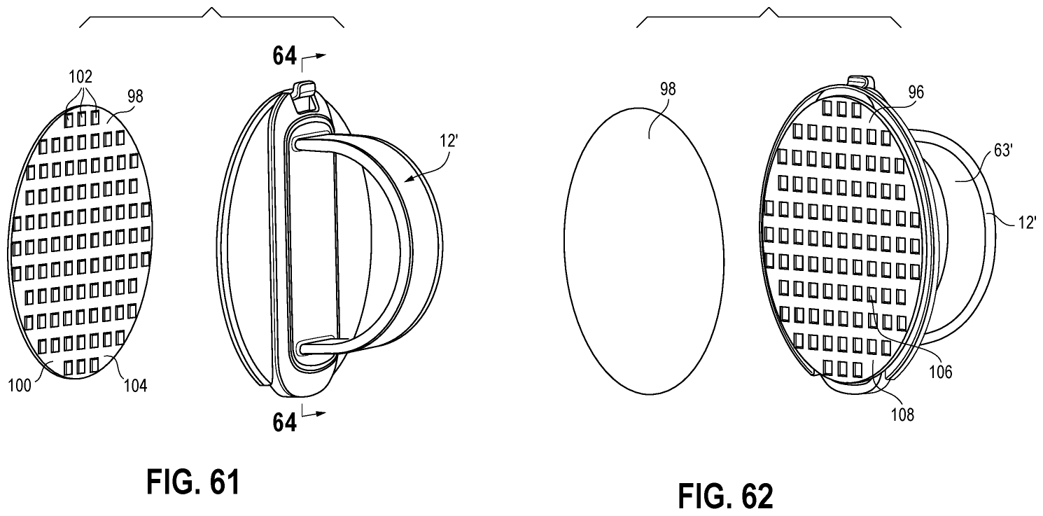

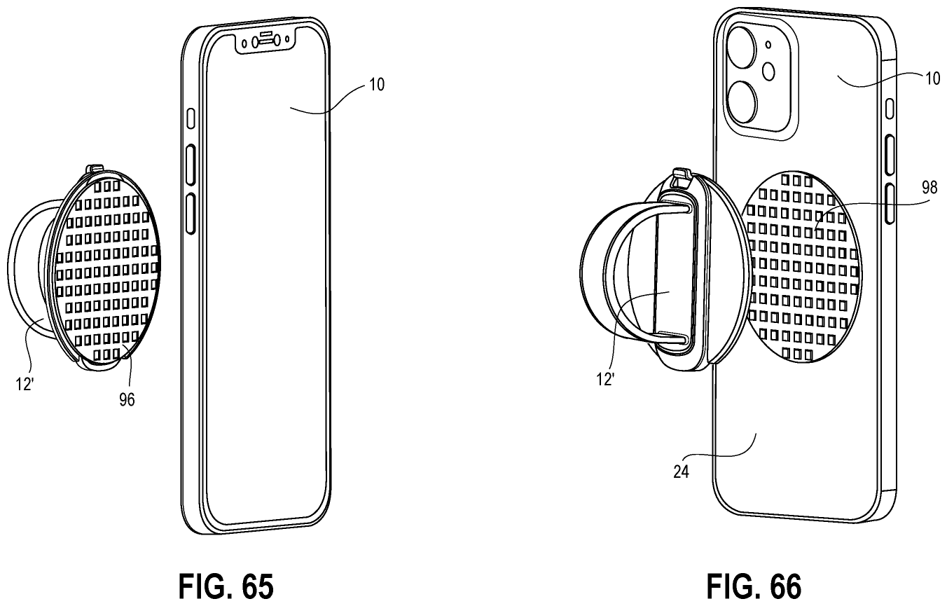

In FIGS. 61-66, an enhanced mounting structure for the exemplary accessory 12′ is shown. The accessory 12′ is shown mounted to a flat surface 24 on a portable electronic device 10 in the form of a cellular phone.

The mounting structure consists of cooperating components 96, 98, respectively on the accessory 12′ and the portable electronic device 10. It should be understood that either of the components 96, 98 could be integrally formed with the accessory 12′ and portable electronic device 10.

As depicted, the components 96, 98 are separately formed and fixed respectively to the accessory 12′ and portable electronic device 10.

The component 98 has a generally flat surface 100 from which discrete elements 102 project in a regular pattern in spaced relationship to each other. A wall 104 defining the elements 102 may be made of any durable material, such as thermoplastic (ABS, HIPS, PC, PP, acetal, etc.). A rigid TPU may also be used if it does not have a high coefficient of friction that would inhibit meshing, as described below. The “male” elements 102 cooperate with “female” elements 106 arranged in a complementary pattern to the pattern of the male elements 102.

A wall 108 on which the female elements 106 are formed may generally be made from the same material as a gripping ring 63′ on the depicted component 12′. The same materials as used for the wall 104 and male elements 102 can be used to form the component 96.

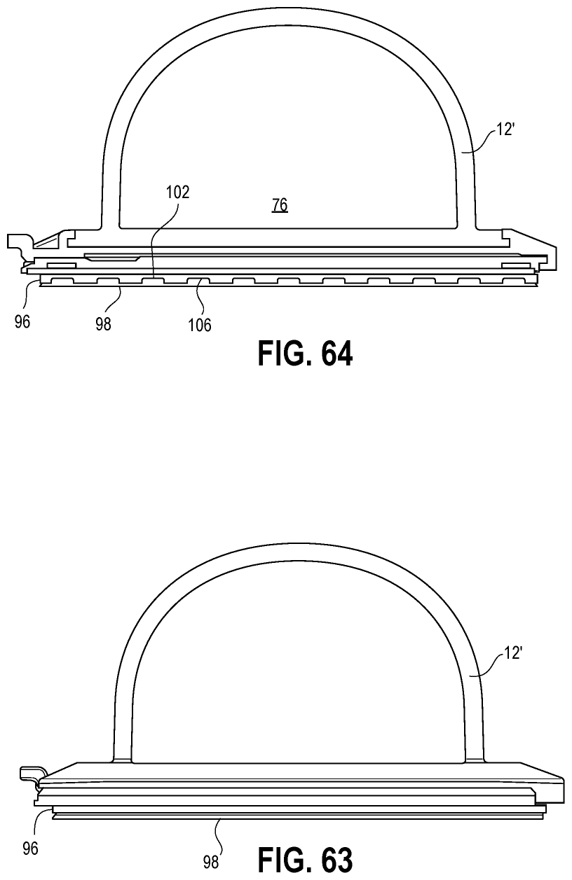

With the components 96, 98 fully joined as in FIG. 63, the male and female elements 102, 106 mesh, as seen most clearly in FIG. 64, to a compact thickness.

With the elements 102, 106 engaged, the components 96, 98 are effectively keyed against moving relative to each other in any manner parallel to the plane of the flat surface 24 on the portable electronic device 10. Such complementary engagement of the elements of the pattern resist or prevent lateral sliding motion of the base and phone or portable electronic device as may inadvertently occur when an accessory is attached or removed from the base.

The component 12′ is fixed against being drawn away from the flat surface 24 on the portable electronic device 10 as by magnets 26, as described above, strategically spaced adhesive, etc.

As previously mentioned, the various bases may be bonded to the portable electronic device 10.

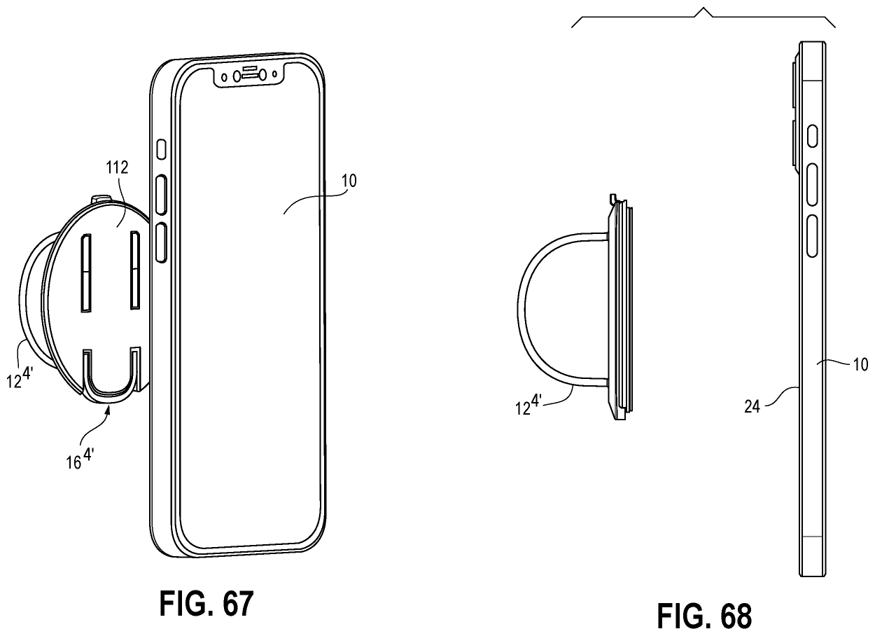

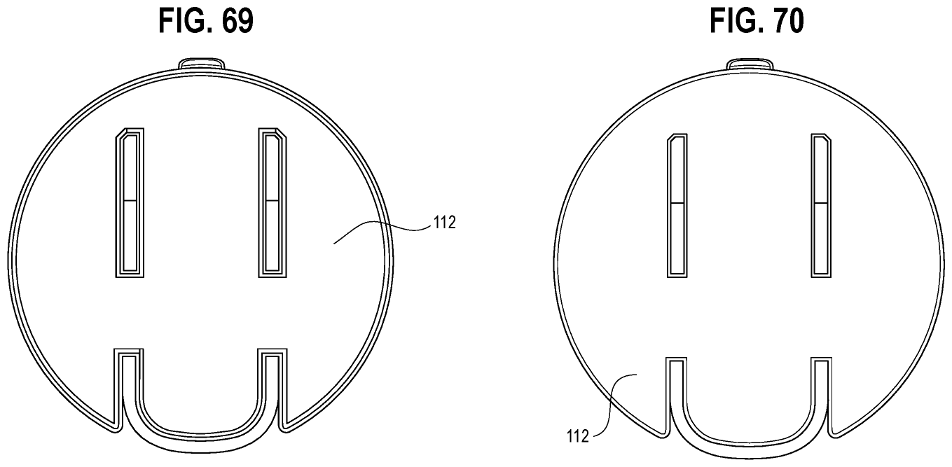

As shown in FIGS. 67-72, an adhesive grip layer 112 is applied in a recessed region 114 on the base 16^{4′} and overlies an optional, magnetic component 26 to cooperate with a magnetic component 115 on the phone 10.

In one exemplary form the gripping layer 112 is made from a nanogrip material. This super adhesive double-sided grip material is made of Nano-PU gel material, with a thickness preferably on the order of 1 millimeter.

Other double-sided adhesive materials are suitable, so long as they are sturdy and durable. Other desirable characteristics of an adhesive layer is that it is transparent, washable, reusable, easy to remove, leaves no trace when removed, etc.

In other exemplary embodiments, the gripping layer is a replaceable or repositionable adhesive allowing the base to be placed onto the phone multiple times. Any gripping layer when used in conjunction with magnets, reduces inadvertent separation while still allowing separation of the magnetic bonding or coupling by increasing the effort or force required for the separation or uncoupling. Such gripping layers also prevent or reduce the ability to laterally displace the base from the phone inadvertently while sliding on or removing an accessory from the base.

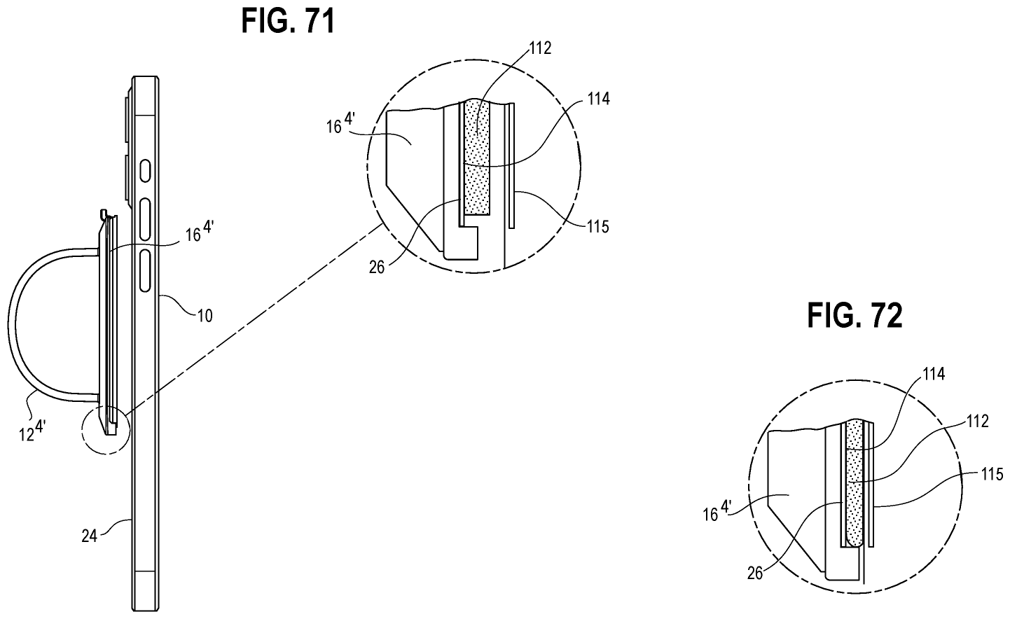

With the gripping layer 112 initially applied, it has the configuration shown in FIGS. 69 and 71.

Once the base 16^{4′} is pressed against the surface 24 and magnetic components 26 and 115 are drawn towards one another, the gripping layer compresses and expands outwardly in all directions, increasing contact area and reducing thickness, as shown in FIGS. 70 and 72.

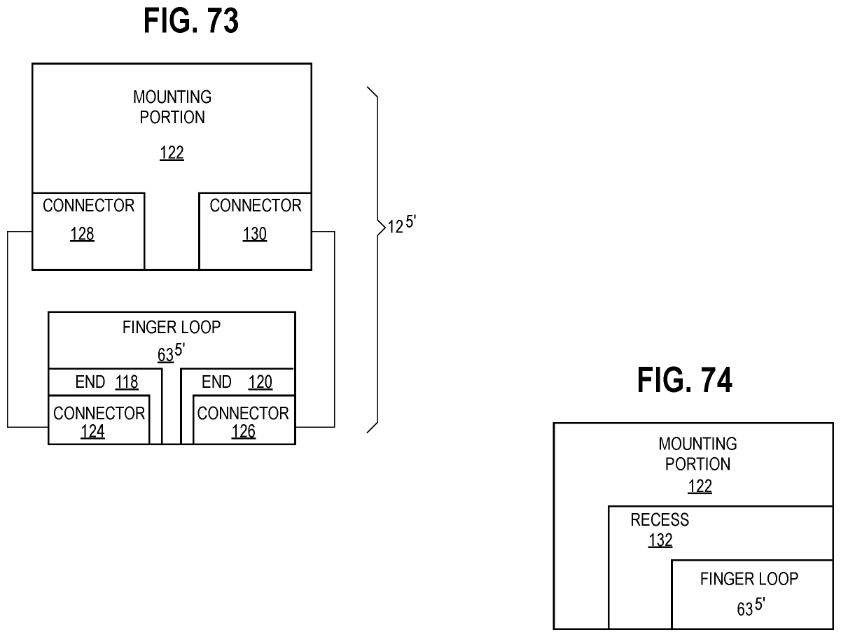

The finger loop 63, 63′, described above, may take many different forms, including that form depicted generically in FIGS. 73 and 74. Generally, the finger loop 63^{5′} is made of a web of material and has a first end 118 and a second end 120. The web of material is preferably flexible, but this is not a requirement.

As shown in FIG. 73, the finger loop 63^{5′} is connected to a mounting portion 122, with the mounting portion 122 and finger loop cooperatively making up the accessory 12^{5′}. The ends 118, 120 of the finger loop respectively have connectors 124, 126. The connectors 124, 126 are in turn configured to cooperate with connectors 128, 130, respectively, on the mounting portion 122.

The generic showing of the cooperating connectors 124, 128; 126, 130 is intended to encompass numerous different variations.

For example, the ends 118, 120 may be joined to the mounting portion 122 through the connectors 128, 130 so that the ends 118, 120 are in a fixed relationship with the finger loop having a predetermined arched shape. Through the connector arrangement, one or both of the ends 118, 120 may be movable along the mounting portion to reconfigure the loop shape. That is, one or both of the ends 118, 120 may be movable relative to each other to accomplish this.

In one form, one or both of the ends 118, 120 are movable to flatten the loop to a compact configuration.

As shown in FIG. 74, the mounting portion 122 may include a recess 132 to accommodate the flattened finger loop 63^{5′} to provide a low profile configuration.

In one form, the finger loop in the folded and stored state in the recess 132 may be engaged by a user and drawn upwardly to a full arched position or an intermediate position. Structure may be provided to maintain different arched shapes.

As depicted, the various bases 16 are in the form of a thin disk or wafer, with oppositely facing surfaces 58, 60 desirably spaced a distance less than 2.2 mm apart. The thickness of the base could, however, be substantially thicker, consistent with the inventive concepts.

Further, one skilled in the art will recognize that the thickness can vary from location to location on each base 16.

In certain embodiments, the base 16 has a perimeter including at least one straight or non-arcuate portion as viewed in plan (see, for example, dotted line perimeter edge in FIG. 28). In other forms, the base may include multiple straight perimeter portions (see, for example, base 16″). Typically, in the latter case, the straight portions are generally even or coextensive with edges of accessories or other structures attached to the base 16.

The straight sections may, but are not required to, be parallel to each other. They may likewise be parallel to the guiding rail structure defined by the various flanges/edges/slots.

In certain embodiments, the perimeter of the base may include a flange or a plurality of flanges. The flange(s) may extend along the entire perimeter or only a portion thereof.

The tabs 42 are shown to generally be at or near the perimeter of each base. While convenient, this is not a requirement.

In certain embodiments, the base 16 has a recess to accept an adhering component, such as a double-sided adhesive. The recess is not required. The adhesive layer may extend outwardly from the surface through which the recess is formed.

In some forms, the base 16 may have a recess with a secondary recess, with the latter accommodating the magnets 26. The magnets 26 may be adhered to or otherwise coupled to the base without regard to a recess. It is also contemplated that the magnets 26 may be encased in the base.

In forms wherein there is a secondary recess, the recess may be a continuous form or may be non-continuous or segmented. Generally, the secondary recess for the magnets is annular, which is either continuous or made up of discrete segments. Each such segment may include a magnet or a plurality of magnets 26. One skilled in the art will recognize that the magnets in any embodiment do not need to be placed in a recess but may be placed on or within the base at particular locations consistent with the above description and Apple's MagSafe specifications.

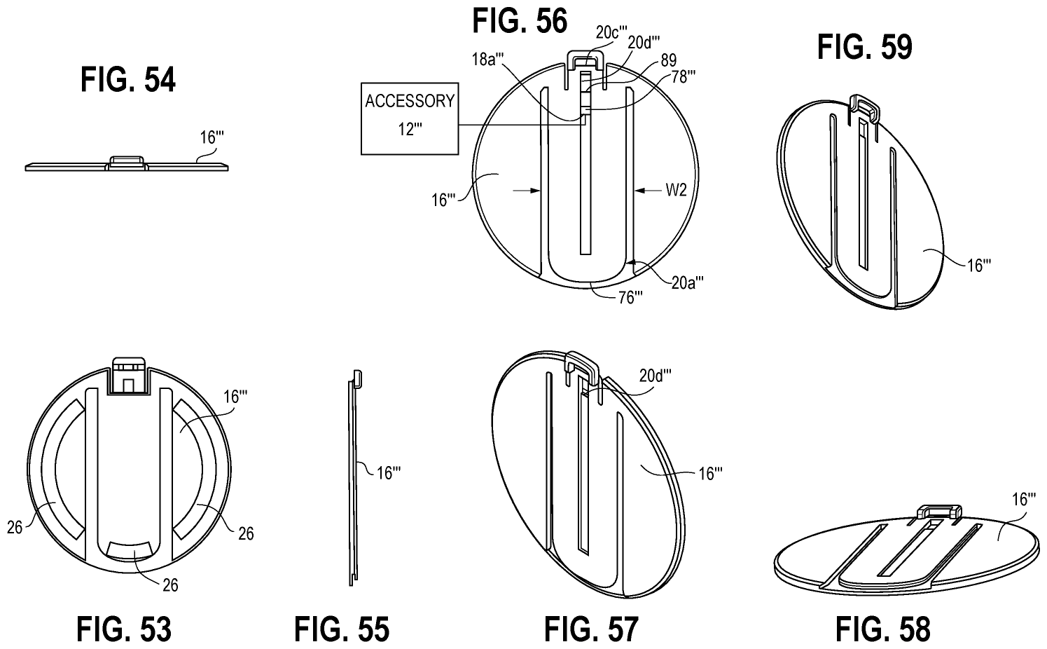

In certain embodiments, such as that in FIG. 53, the magnets 26 may have a segment located in an arc between one side of the edge/connector part 20a″ and the perimeter of the base 16. A second segment may be located diametrically oppositely, with a third segment within the width W2 as seen in FIG. 56.

In certain embodiments, lengths of the guide slot/connecting part 18a′ are generally parallel to each other and in communication with each other at or adjacent a perimeter region of the base. In other forms, these lengths do not extend to the perimeter.

As noted above, in certain embodiments, the base and accessory are formed in such a manner that at least one “rail” and “slot” are formed on each base and accessory.

One skilled in the art will recognize that other complementary structures may be used to engage the base and accessory in a slidable relation for engagement and disengagement while providing sufficient contact.

In one preferred form, the inturned ends 34a′, 34b′ engage below the upper surface of the base with at least 0.6 mm of material thickness maintained for the base above and below the inturned ends 34a′, 34b′.

In one preferred form, the edge-/flange-forming part of the “rail” continues to define an overall “U” shape with the base of the “U” at one end. The accessory engages at least partially along the length of the legs of the “U” as well as the base of the “U”.

The “U” shape of the edge/flange produces curved segments at the base of the “U” to facilitate alignment and guidance between the base and accessory. The provision of a guide channel/connecting part 20b″ further enhances alignment and guidance in relative movement between the base and accessory.

In certain embodiments, the base has a generally circular perimeter with the guide “rails” and “slots” located within the perimeter. Alternatively, the “rails” and “slots” are defined at or along straight perimeter edges, as on the base 16″ and accessory 12″.

The guide channel/connector part 20b″ in FIG. 46 has a first end displaced inwardly from a perimeter end 76 of the base 16″. This allows for enhanced positioning of the projection 78 when the accessory 12″ is placed in the guide position prior to sliding into engagement with the base 16″. In various forms shown, the channel terminates at a holding surface/connector part to engage the projection.

In some embodiments, the guide channel may terminate at a ramp along which the projection rides to displace the locking projection. The projection extends beyond the perimeter and is resiliently modeled with a live hinge to allow bending thereof. In one form, the tab is displaced toward the bottom of the base. The guide channel may also include an aperture/seat at or near the end which, with the projection seated therein, prevents the accessory from sliding back to reverse the connecting direction of movement of the accessory. The aperture/seat may be formed within a resilient web of material and may have surrounding walls that are angled to allow the projection to displace the distal end of the tab as the accessory is moved into its connected relationship with the base.

In certain embodiments, the exemplary projection 78 is offset from the bottom of the base to allow the tab 42 to have sufficient room to be displaced downward to accept and hold the projection on the accessory. The tab has a holding surface that is preferably vertical to resist backward travel of the accessory once in the connected relationship with the base. The holding surface may be part of an aperture, seat, depression, or ridge.

In some embodiments, the holding surfaces may have an angled or ramped configuration to allow the projection on the accessory to pass thereover with the application of a force greater than a predetermined level that would be considered greater than a force inadvertently produced as the system is handled.

In certain embodiments, the tab may have multiple holding surfaces. A second holding surface may have a vertical or edge or may have an angle or ramp as with the above-described holding surface. The holding surfaces on the projection and base interact as a backup engagement or securing mechanism. The second holding surface may be defined by a wall bounding an aperture/seat on the tab.

The tab 42 preferably has a readily accessed portion adjacent the holding surface(s) to allow the user to thereat engage and bend the tab upwardly and downwardly to disengage the holding surfaces, whereupon the accessory can be translated oppositely to the direction it is moved in effecting connection with the base.

In some embodiments, the base may include a projection that interacts or registers with a depression/seat on the accessory with the accessory in its connected relationship with the base. Either or both of the projection and depression/seat may include angled walls to allow the projection to slide in and out of registration with holding surfaces bounding the same with the application of a predetermined moderate force. This interaction provides additional resistance to unwanted or inadvertent disengagement of the accessory from the base as may occur if the tab is inadvertently bent either upwardly or downwardly, depending upon the design. This interaction provides a secondary structure to prevent or resist inadvertent translation of the accessory away from the base starting initially in the connected relationship with the base.

The foregoing disclosure of specific embodiments is intended to be illustrative of the broad concepts comprehended by the invention.

1. In combination:
a portable electronic device;
a base on the portable electronic device and having at least one connector part; and
an accessory usable with the portable electronic device and having at least one connector part,
the at least one connector part on the base and at least one connector part on the accessory configured to cooperate such that: a) the accessory is movable from a starting position, fully spaced from the base, to against the base and guidingly relative to the base in translation in a first direction along a first path portion towards one fully connected relationship with the base;
and b) with the accessory in the one fully connected relationship with the base the accessory is blocked from being separated from the base.

2. The combination according to claim 1 wherein the at least one connector part on the base comprises a holding surface and the at least one connector part on the accessory comprises a holding surface that moves relative to the holding surface on the base and into confronting relationship with the holding surface on the base, as an incident of the accessory moving into the one fully connected relationship with the base, to block the accessory from being moved out of the one fully connected relationship.

3. The combination according to claim 2 wherein the holding surfaces are placed in confronting relationship as an incident of the accessory being moved in the first direction along the first path portion and into the one fully connected relationship with the base whereupon the holding surface on the accessory is moved up to and past the holding surface on the base.

4. The combination according to claim 3 wherein there is a deflectable tab on one of the accessory and base on which the holding surface on the one of the accessory and base is located and with the accessory in the one fully connected relationship the tab can be repositioned to change a relationship between the holding surfaces on the accessory and base thereby allowing the accessory to be moved out of the one fully connected relationship.

5. The combination according to claim 1 wherein the at least one connector part on the accessory and the at least one connector part on the base that cooperate to guide the accessory in translation along the first path portion comprise at least one rail on one of the accessory and base that cooperates with at least one slot on the other of the accessory and base.

6. The combination according to claim 1 wherein the accessory is at least one of: a) a finger loop; b) a case; c) a wallet; d) a mounting base; e) a kickstand; and f) a car mount.

7. The combination according to claim 1 wherein the base is attached to a substantially flat surface on the portable electronic device residing in a first plane and the at least one rail and at least one slot are configured so that the accessory is blocked in movement relative to the base orthogonally to the first plane and away from the substantially flat surface on the portable electronic device.

8. The combination according to claim 4 wherein the base is attached to a substantially flat surface on the portable electronic device and the tab is repositioned by drawing a part of the tab away from the substantially flat surface on the portable electronic device.

9. The combination according to claim 1 wherein the accessory is moved in translation against and relative to the base in the first direction from the starting position into the one fully connected relationship.

10. The combination according to claim 1 wherein the at least one connector part on the base and at least one connector part on the accessory are configured to cooperate such that: a) the accessory is movable from a starting position, fully spaced from the base, to against the base and guidingly against and relative to the base in translation in a second direction along a second path towards another connected relationship with the base; and b) with the accessory in the another fully connected relationship with the base the accessory is blocked from being separated from the base.

11. The combination according to claim 1 wherein the at least one connector part on one of the base and accessory comprises a discrete projection that is movable guidingly in a channel defining the at least one connector part on the other of the base and accessory as the accessory is moved in translation in the first path.

12. The combination according to claim 1 wherein the base is attached to a substantially flat surface on the portable electronic device and residing in a first plane and the at least one rail and one slot are configured to define a captive rail arrangement that blocks the accessory from being drawn away from the substantially flat surface on the portable electronic device orthogonally to the first plane.

13. The combination according to claim 3 wherein the accessory is moved in translation against and relative to the base in the first direction from the starting position into the one fully connected relationship and with the holding surfaces on the base and accessory in confronting relationship the accessory is blocked from moving in translation against and relative to the base oppositely to the first direction.

14. The combination according to claim 1 wherein the at least one connector part on one of the base and accessory comprises a projection and the at least one connector on the other of the base and accessory comprises a seat for the projection, the seat having oppositely facing holding surfaces that abut the projection to block movement of the accessory in translation relative to the base in the first direction and oppositely to the first direction.

15. The combination according to claim 1 wherein the at least one connector on the base comprises first and second spaced base holding surfaces and the at least one connector on the accessory comprises first and second spaced accessory holding surfaces, the first and second spaced base holding surfaces respectively in confronting relationship with the first and second spaced accessory holding surfaces to block the accessory from being moved out of the one fully connected relationship.

16. The combination according to claim 1 wherein the base has at least one magnet that overlies an area of a surface on the portable electronic device.

17. The combination according to claim 16 wherein the portable electronic device includes at least one magnet, the base further including a gripping layer, the gripping layer positioned between the magnet on the base and the magnet on the portable electronic device.

18. The combination according to claim 5 wherein the at least one connector part on the base comprises a U-shaped edge with spaced substantially parallel lengths and an end portion connecting the spaced substantially parallel lengths to define a “U” shape and the at least one connector part on the accessory comprises a U-shaped slot that receives at least a part of each of the spaced substantially parallel lengths and the end portion of the U-shaped edge with the accessory in the one fully connected relationship with the base.

19. The combination according to claim 1 wherein the base includes a pattern with discrete elements to engage a complementary pattern on the portable electronic device.

20. The combination according to claim 1 wherein the base includes a second connector part, the second connector part positioned at an angle to the first connector part, the second connector part providing a second path portion for a second connected relationship between the base and the accessory.
